(19) United States
(12) Patent Application Publication
(10) Pub. No.: US 2009/0171846 A1
(43) Pub. Date: Jul. 2, 2009

(54) Contactless Payment Through Satellite Radio Devices

(75) Inventor: Frederick F. Branca, JR., Patterson, NY (US)

Correspondence Address: HOFFMANN & BARON, LLP, 6900 JERICHO TURNPIKE, SYOSSET, NY, 11791, US

(73) Assignee: MasterCard International, Inc., Purchase, NY (US)

(21) Appl. No.: 12/326,217

(22) Filed: Dec. 2, 2008

Related U.S. Application Data
(60) Provisional application No. 61/016,986, filed on Dec. 27, 2007.

(51) Int. Cl. G06Q 40/00

(52) U.S. Cl. 705/44

(57) ABSTRACT

A method and system for making a purchase using a payment card and a satellite radio. The method includes: broadcasting information relating to goods or services for sale via a satellite radio; receiving a request to purchase goods or services via a satellite radio that includes a payment card account number; identifying subscriber account information based on the payment card account number; submitting a request for payment authorization; receiving an authorization and delivering the goods or services to a purchaser. The system includes: a satellite radio that has a receiver and a transmitter; radio programming that includes an advertisement for the sale of goods or services; a payment card with a microprocessor chip or a magnetic stripe that contains account information and a payment card reader connected to the satellite radio for reading the account information from the microprocessor chip or magnetic stripe.

This application claims priority from provisional application Ser. No. 61/016,986, filed on Dec. 27, 2007, which is incorporated herein in its entirety.

### FIELD OF THE INVENTION

The present invention relates to financial transactions using payment cards and satellite radio devices. In particular, the present invention relates to transacting payment card purchases using satellite radio devices.

### BACKGROUND OF INVENTION

Satellite radio provides subscription radio services to users for specific types of programming. The satellite transmission of the radio signals allows listeners to travel across an entire continent and access the same audio programming anywhere they go. Radio listeners traveling in cars can listen to programs without interruption and are no longer tethered to transmissions from land-based radio transmitters. As long as the antenna used with the receiver has a clear view to the satellites, the listener receives uninterrupted radio programs. In areas where tall buildings, bridges, or even parking garages obscure the signal, repeaters can be used to make the signal available to listeners. Local repeaters similar to broadcast translator boosters enable signals to be available even if the view of the satellite is blocked by skyscrapers or in tunnels. Repeaters also allow local programming, such as traffic and weather, to be transmitted in most major metropolitan areas.

A satellite radio or subscription radio (“SR”) is a digital radio signal that is broadcast by a communications satellite, which covers a much wider geographical range than terrestrial radio signals. Radio services are usually provided by commercial ventures and, typically, are subscription-based. The various services are proprietary signals, requiring specialized hardware for decoding and playback. Providers usually carry a variety of news, weather, sports, and music channels, with the music channels generally being commercial-free.

Satellite radio uses the 2.3 GHz S band in North America and generally shares the 1.4 GHz L band with local Digital Audio Broadcasting (“DAB”) stations in other parts of the world. The satellite signal is a type of direct broadcast and it is strong enough so that a satellite dish is not required to receive it. The curvature of the earth limits the reception of the signal, but due to the high orbit of the satellites, two or three satellites are usually sufficient to provide coverage for an entire continent.

Each satellite radio receiver has an Electronic Serial Number (“ESN”) Radio ID to identify it. When a unit is activated with a subscription, an authorization code is sent in the digital stream telling the receiver to allow access to the blocked channels. Most services have at least one “free to air” or “in the clear” channel as a test. The ESN allows the satellite radio service to restrict access to the broadcast satellite signals to subscribers and prevents non-subscribers from receiving the signals.

Satellite radio technology is well known and widely used. Similarly, payment card transactions are also well known and widely used. Payment cards, such as credit cards, debit cards and prepaid cards, are typically either swiped or inserted into a card reader that retrieves information stored on a magnetic stripe or in a microprocessor chip. The magnetic stripe or “magstripe” stores data by modifying the magnetism of tiny iron-based magnetic particles on a band of magnetic material on the card. The magnetic stripe is read by physical contact and swiping past the head of the card reader. Cards with microprocessor chips are called “smart cards.” The microprocessor chip stores information on the card and the information is accessed by a reader that provides energy to power the microprocessor chip. Smart cards increase the security of payment cards and other similar devices and provide cardholders with additional functionalities.

In general, a smart card (also referred to as chip cards or integrated circuit cards (ICC)) is a payment card with embedded integrated circuits that can process information, i.e., it can receive input which is processed—by way of the ICC applications—and delivered as an output. The smart cards can be either memory cards, which contain only non-volatile memory storage components, and perhaps some specific security logic, or microprocessor cards, which contain volatile memory and microprocessor components. The microprocessor on the smart card provides security by allowing the host computer and card reader to actually “talk” to the microprocessor. The applications of smart cards include their use as credit or ATM cards, in a fuel card, SIMs for mobile phones, authorization cards for pay television, pre-pay utilities in household, high-security identification and access-control cards, and public transport and public phone payment cards.

Subscription satellite radio providers can broadcast programs prepared for individual listeners. Typically, these programs with customer specific content are offered in addition to the programs that are provided as part of a standard subscription. These additional programs are usually purchased over the internet or by telephone. However, at the present time, there is no way for a satellite radio subscriber to purchase goods and services that are advertised on a satellite radio program. Moreover, there is no system for making payments over a satellite radio to purchase advertised goods and services. Accordingly, there is a need for a system and a method that allows consumers to make purchases of goods and services advertised on satellite radio using a payment card that is interactive with a satellite radio.

### SUMMARY OF THE INVENTION

In accordance with the present invention, a method and system for making a purchase using a payment card and a satellite radio is provided. The method includes: broadcasting information relating to goods or services for sale via a satellite radio; receiving a request to purchase goods or services via a satellite radio that includes a payment card account number; identifying subscriber account information based on the payment card account number; submitting a request for payment authorization; receiving an authorization and delivering the goods or services to a purchaser. The payment card used to purchase goods or services can be a credit card, a debit card or a prepaid card and the subscriber account information can include a shipping address.

Preferably, a first radio frequency is used for broadcasting the information about the goods or services for sale and a second radio frequency is used for the purchase request. The broadcast information can include a code for identifying the goods or services when the purchase is made. The code is visually displayed on the satellite radio during the broadcast of the advertisement and can be saved by pressing a keypad, a touch screen or a touch pad connected to the satellite radio. After the purchase request is made, it can be assigned an order number and the purchase can be confirmed via the satellite radio or by an electronic message preferably an e-mail or a text message. To prevent fraudulent use of the system, the goods or services are preferably delivered to a location or locations identified in the subscriber account information.

The system of the present invention for making a purchase using a payment card and a satellite radio includes: a satellite radio that has a receiver and a transmitter; radio programming that includes an advertisement for the sale of goods or services; a payment card with a microprocessor chip or a magnetic stripe that contains account information; a payment card reader connected to the satellite radio for reading the account information from the microprocessor chip or magnetic stripe, wherein the account information is transmitted via the satellite radio transmitter to purchase the advertised goods or services; and software for receiving the account information and completing a sales transaction for the purchase of the advertised goods or services. The satellite radio can have one or more channels for receiving and transmitting satellite radio signals. The satellite radio can also include a first radio frequency for receiving the radio programming and a second radio frequency for transmitting the account information. Preferably, the satellite radio or the payment card reader includes a display screen and the advertisement is assigned a code, which is displayed on the display screen.

The system can also include a keypad, a touch screen or a touch pad for entering information that can be transmitted via the satellite radio. The purchase is preferably made using the keypad, touch screen or touch pad and the payment card. The completed sales transaction is assigned an order number, which is transmitted to a purchaser via the satellite radio, an e-mail or a text message. The account information includes one or more shipping addresses and the purchased goods or services can only be shipped to this shipping address.

### BRIEF DESCRIPTION OF THE FIGURES

The preferred embodiments of the method and system for making a purchase using a payment card and a satellite radio of the present invention, as well as other objects, features and advantages of this invention, will be apparent from the accompanying drawings wherein:

FIG. 1 is a flowchart showing a satellite radio subscriber responding to an advertisement and making a purchase via a satellite radio.

FIG. 2 shows a satellite radio transmission from a ground station to a subscriber's radio via a satellite.

FIG. 3 shows a radio transmission from a ground station to an car radio via satellite radio communication.

FIG. 4 is a perspective view of a satellite radio in accordance with the present invention.

### DETAILED DESCRIPTION OF THE INVENTION

The present invention provides a system and a method for conducting a secure sales transaction for the sale of goods and services using satellite radio communications and a payment card. The ability to restrict satellite radio transmissions to specific subscribers provides at least a partially secure method of communication using a satellite radio that can both receive and transmit satellite radio signals. In addition, the satellite radio is equipped with a payment card reader or scanner that can read the information stored in the magnetic stripe or microprocessor of a payment card. The payment card reader can be an integral part of the radio or it can be an external device connected to the radio. It can also be a separate wireless device. The payment card reader communicates the card information to the satellite radio for transmission. To make a purchase of goods and services advertised on radio broadcasts, a satellite radio subscriber swipes or scans a payment card while the advertisement is being broadcast or enters a code number for the product and swipes or scans a payment card after the broadcast. The payment card reader communicates the card information to the satellite radio for transmission. The payment card information and any additional information entered using the radio's keypad and/or touch screen are transmitted via a satellite radio transmission to the satellite radio merchant for processing and completing the purchase.

Satellite devices are becoming smaller and more readily adaptable to the “on-the-go” consumer. The present invention combines card “swipe” or contactless payment capabilities (i.e., microprocessor chip and antenna) with a satellite radio so that a subscriber can make payments for goods purchased from a satellite radio merchant. The term “microprocessor chip” as it is used herein includes all types of chips and integrated circuits that are used in contact and contactless smart card technology, including, but not limited to, proximity cards and cards used for radio-frequency identification (“RFID”). The card swipe system or the smart card system can include either a peripheral device connected to the satellite radio or the system can be an integral part of the radio, designed as part of the satellite radio unit. The satellite radio system can include an antenna, a satellite radio receiver/transmitter having a display, a keypad, a touch screen or a touch pad and a device for reading information from a payment card (i.e., reading the magnetic stripe or microprocessor chip). The system also includes software for tracking satellite radio advertisements and interacting with the purchaser to accept payment and process the transaction.

The satellite radio provider advertises the sale of goods and services in satellite radio broadcasts that are received by satellite radio subscribers. For the purposes of this disclosure, the seller of the goods and services advertised on satellite radio is referred to as “the satellite radio provider,” “the satellite radio merchant” or “the merchant.” However, the identity or appellation of the advertiser/seller is not intended to limit the scope of the invention in any way and any party that advertises on satellite radio broadcasts and accepts orders transmitted via satellite radio communications would be included. Similarly, the identity of the subscriber/purchaser is not intended to limit the scope of the invention.

The satellite radio advertisements can be broadcast during programs offered by the satellite radio provider or the advertisements can be broadcast as an independent program similar to shop-at-home television programs. A subscriber can purchase the advertised goods and services by transmitting an order via a satellite radio using a payment card. In one embodiment, the purchase can be made by swiping or scanning a payment card while the advertisement is being aired. In another embodiment, a code, which is valid for a predetermined period of time, is displayed on the satellite radio when the advertisement is broadcast. The subscriber enters this code along with the payment card information when making a purchase. In addition to conducting sales transactions via satellite radio, the method also includes conducting sales transactions using a satellite television that is equipped with a transmitter so that it has the same functionality as the satellite radio described herein.

The method of the present invention requires a satellite radio that can receive as well as transmit satellite radio transmissions. To make a purchase, a satellite radio subscriber swipes a payment card or scans a contactless card in the satellite radio's reader, enters the code number for the goods or services being purchased and optionally enters a PIN (personal identification number) and other information such as quantity, size and shipping address. Preferably, the account has one or more shipping addresses that can be used and the subscriber selects one of the addresses for a particular purchase. The payment card reader can be in the satellite radio or provided as a peripheral device and connected to the radio. The entered information is transmitted by the satellite radio to the satellite service provider where the information is entered in a payment device that verifies the purchaser's information, submits a request for payment authorization, receives an authorization, completes the transaction and sends an order confirmation to the purchaser via the satellite radio. The process of completing a payment card transaction by requesting authorization from the payment card issuer is well known and, typically, includes the submission of payment card information as well as information pertaining to the purchase and the seller. In preferred embodiments, the satellite service provider does not process the order, but forwards the information to the advertiser who then processes and completes the order. The payment device can be a standard computer based system for processing payment card transactions similar to systems that are used to process orders for internet purchases.

A subscriber traveling in a car can select programs that are dedicated to advertising the sale of different types of products and services. This would be similar to television networks that are dedicated to selling products, such as the Home Shopping Network. As the products advertised on the satellite radio program are described, a code for the product is shown on the satellite radio display. This code can be used for a predetermined period of time by a satellite radio subscriber to make a purchase. For example, after a product is advertised, it can be purchased during the following 24 or 48 hours by entering the code and swiping or scanning a payment card in the satellite radio card reader.

In a preferred embodiment, the satellite radio subscriber provides the satellite radio provider with a payment card number and one or more shipment addresses which are maintained in a secure database. The satellite radio provider can then issue the subscriber a payment card that can only be used with the subscriber's satellite radio. When the payment card is swiped and the information is transmitted over the satellite radio, there is minimal risk of the transmission being intercepted and used by a fraudster. Moreover, the method can limit where orders placed by the subscriber can be shipped. Preferably, the subscriber provides a list of predetermined shipping addresses. Thus, even if the payment card is lost or the information stolen, a fraudster or unauthorized user would be unable to make purchases that would be shipped to his or her unauthorized address.

In one embodiment, the subscriber can respond to advertisements broadcast on the radio by “tapping” a contactless payment card on the face of the radio to read the information from the card. The radio then transmits the information to the satellite service provider for completion of the transaction. In another embodiment, the method includes a card reader that incorporates card swipe enablement into a satellite radio. A user wishing to make a purchase simply swipes a payment card through a reader which then transmits the account information on the card via the satellite radio to a computer-based system that processes the transaction.

Preferably, the information about the advertised goods or services is displayed on the screen of the satellite radio along with pricing information. A subscriber makes a purchase using a contactless payment card or card swipe to enter payment information for the transaction, which is then transmitted via the satellite radio. Upon receiving this transmission, a payment device completes the transaction in the same manner as an internet transaction and provides the purchaser with an order confirmation via the satellite radio. A confirmation can also be sent via e-mail or regular mail.

The present invention combines payment card technology, using both contact devices (e.g., swipe card readers) and contactless devices (e.g., a microprocessor chip and antenna) and a satellite radio capable of reading information from such payment cards and transmitting the information to transact a purchase. The term “contactless” as used herein refers to a smart card, in which the chip communicates with the card reader through radio frequency identification (“RFID”) induction technology. These cards require only close proximity to an antenna to complete a transaction and are often used in those locations where quick processing of transactions is desirable and, in some cases, the consumer can even present payment hands-free. For example, smart cards are used on many mass transit systems, where the cards can be used without even removing them from a wallet. The payment card reading functionality of the satellite radio can be an integral part of the radio design or it can be provided by peripheral devices connected to the radio.

For the purposes of the present disclosure, the term “payment cards” is used generically to refer to all of the different types of credit cards, debit cards and prepaid cards, including smart cards and cards with magnetic stripes, without regard to the intended use or function of the card. The methods disclosed herein can be used for making payments using any type of payment card and the use of other terms, such as credit card, debit card and prepaid card, to describe the card used is not intended to limit the scope of the invention in any manner.

In addition to satellite radios installed in automobiles and other vehicles (including boats and air planes), the satellite radio used in the present invention can be a tabletop model used in a home or business or a portable device. The design, configuration and installation of the satellite radio are not intended to limit the invention in any manner. Also, the peripheral equipment required for the proper operation of the satellite radio such as power supplies, antennas and speakers are not intended to be a limitation.

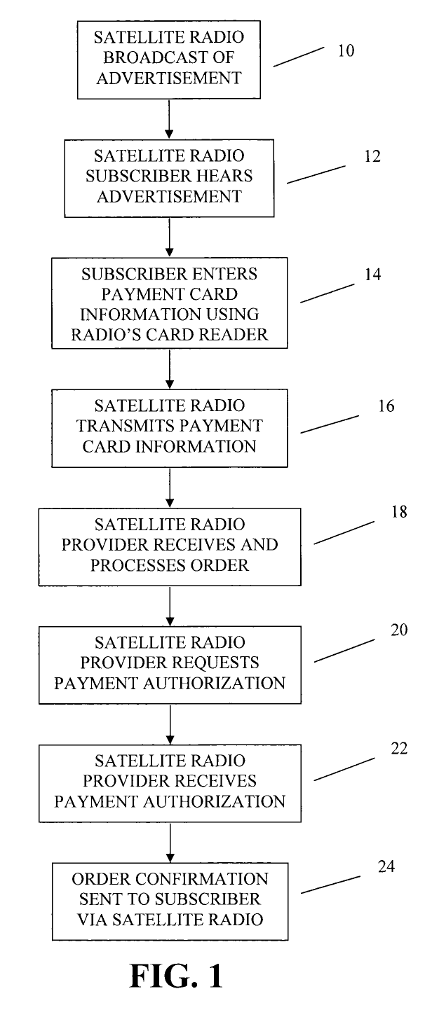

Referring now to the drawings, FIG. 1 is a flow chart for a purchase of an advertised item using a satellite radio. The satellite radio service provider broadcasts an advertisement 10 to satellite radio subscribers. A subscriber hears the advertisement 12 and, if the subscriber wishes to purchase the advertised item, he or she enters payment card information using the satellite radio's card reader 14. The satellite radio then transmits the subscriber's payment card information 16 to the satellite radio service provider along with other information such as the quantity being purchased and shipment information. The satellite radio service provider receives the payment card information and processes the order 18. If necessary, questions about the order can be transmitted to the subscriber via the satellite radio. The satellite radio service provider then submits a request for payment authorization 20 to the issuer of the payment card. After the satellite radio service provider receives the payment authorization form the payment card issuer 22, the order is completed and the satellite radio service provider transmits an order confirmation to the subscriber 24.

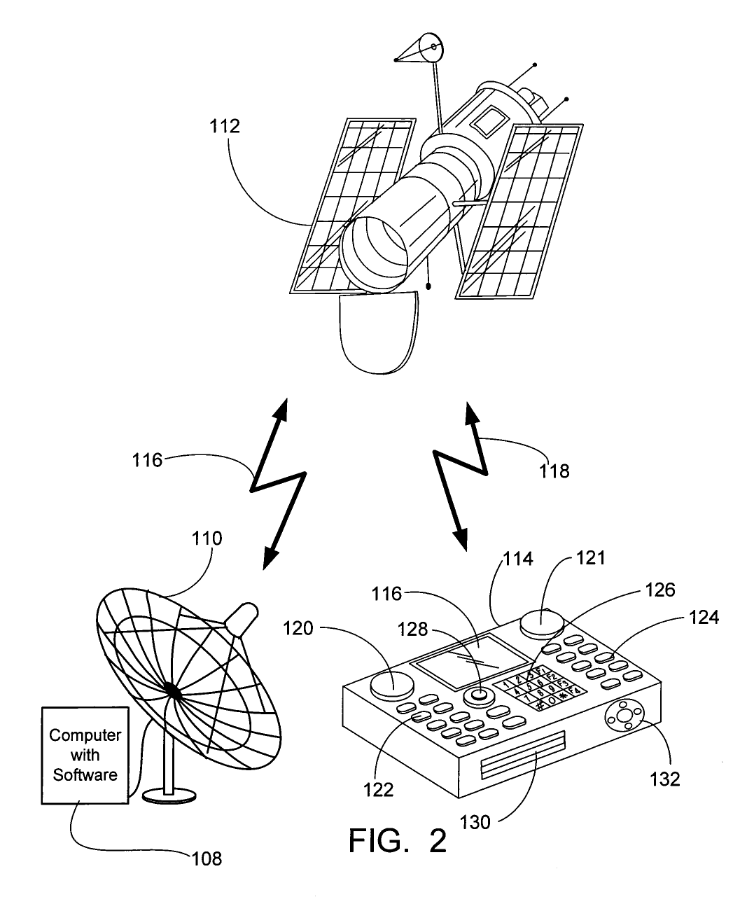

FIG. 2 shows how the satellite radio communication works. A ground station 110 transmits a signal 116 containing a satellite radio program to a satellite 112 in orbit above the earth. The satellite 112 retransmits 118 the program to a subscriber's radio 114. When a subscriber places an order via the satellite radio 114, the order is transmitted 118 to the satellite 112, which retransmits 116 the order to the ground station 110 and then to a computer with software 108 for processing the order. The subscriber's radio 114 can be a portable radio or a fixed installation such as an automobile radio.

The satellite radio 114 in FIG. 2 has a visual display screen 116, a volume control 120, a channel selector 121, a plurality of buttons 122 for pre-selected channels and a plurality of buttons 124 for switching between the receive and transmit mode and adjusting the sound quality. In addition, the satellite radio 114 also has a keypad 126 and a purchase button 128 for placing an order in response to an advertisement on the satellite radio 114. The satellite radio 114 also has a contact card reader 130 and a contactless card reader 132. Either the contact card reader 130 or the contactless card reader 132 can be used for making a purchase using the satellite radio 114.

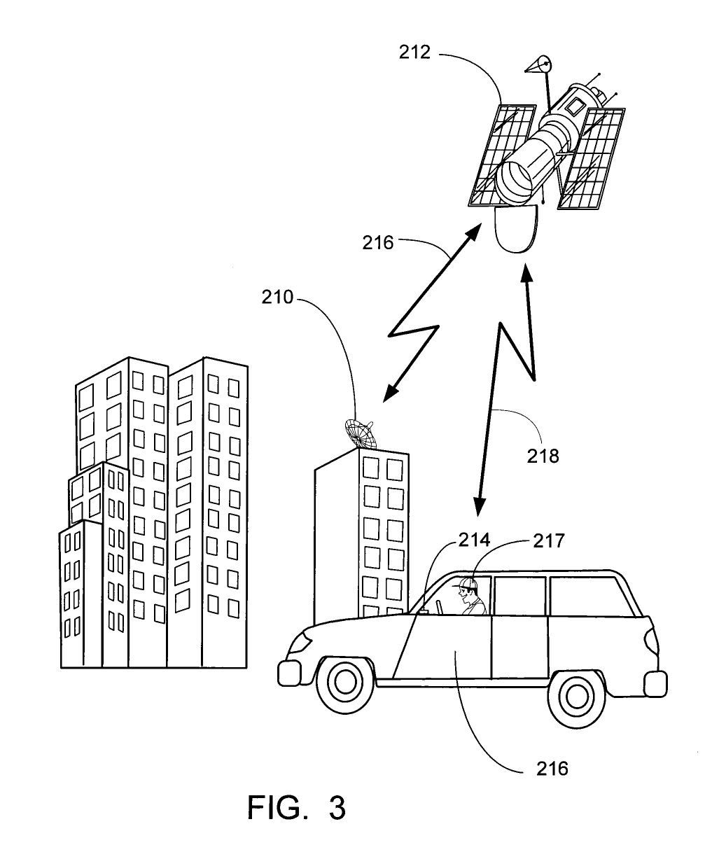

FIG. 3 shows a ground station 210 sending and receiving signals 216 to a satellite 212 for retransmission 218 to a subscriber's satellite radio 214 in an automobile 216. To conduct a purchase transaction, the ground station 210 transmits 216 an advertisement to the satellite 212, which retransmits 218 the advertisement to the subscriber's satellite radio 214. If the subscriber 217 decides to purchase the item advertised, the subscriber 217 transmits 218 a purchase request using the satellite radio 214 and a payment card (not shown) to the satellite 212, which retransmits 216 the purchase request to the ground station 210.

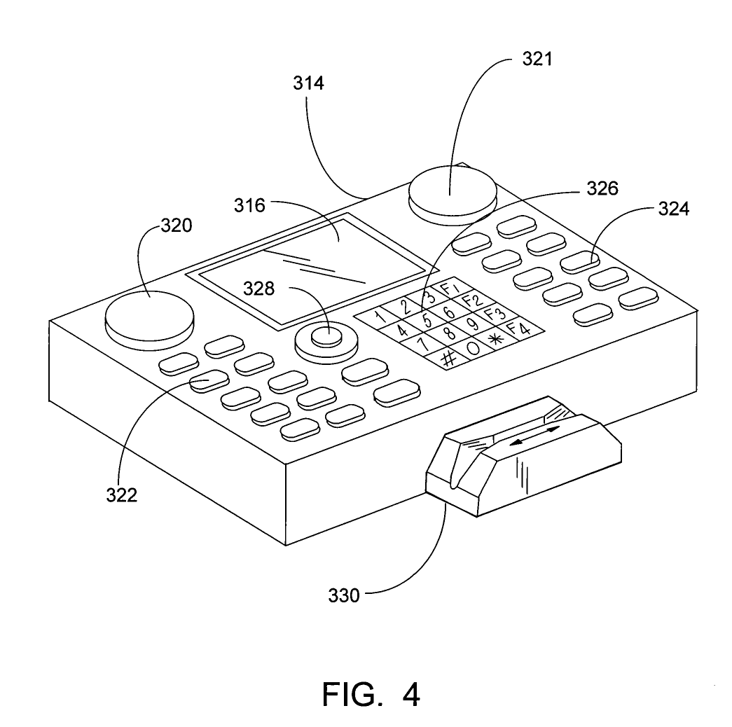

FIG. 4 shows a preferred embodiment of a satellite radio 314 of the present invention. The satellite radio 314 has a visual display screen 316, a volume control 320, a channel selector 321, a plurality of buttons 322 for pre-selected channels and a plurality of buttons 324 for switching between the receive and transmit mode and adjusting the sound quality. In addition, the radio 314 also has a keypad 326, a purchase button 328 and a card reader 330. When a satellite radio subscriber hears an advertisement for a product or service on the radio 314 that the subscriber wishes to purchase, a code is displayed on the display screen 316. While the code is displayed, the listener can push the purchase button 328 and begin a purchase or, after the code is no longer displayed, the listener can enter the code using the keypad 326 to begin a purchase. In either case, the subscriber completes the purchase using the card reader 330 to enter payment card information (such as a credit card, debit card or prepaid card) and, optionally, a PIN. In preferred embodiments, the subscriber is then prompted by messages displayed on the display screen 316 to select a quantity, a shipping method, a shipping address and other information pertaining to the order. Responses to these prompts can be entered by the subscriber using the keypad 326. When the purchase is completed, an order confirmation can be displayed on the display screen 316 and/or e-mailed or text messaged to the subscriber. Alternatively, an order confirmation can be sent via regular mail.

Thus, while there have been described the preferred embodiments of the present invention, those skilled in the art will realize that other embodiments can be made without departing from the spirit of the invention, and it is intended to include all such further modifications and changes as come within the true scope of the claims set forth herein.

We claim:

1. A method for making a purchase using a payment card and a satellite radio comprising:
broadcasting information relating to goods or services for sale via a satellite radio;
receiving a request to purchase goods or services via a satellite radio, wherein the request includes a payment card account number;
identifying subscriber account information based on the payment card account number;
submitting a request for payment authorization;
receiving an authorization; and
delivering goods or services to a purchaser.

2. The method for making a purchase using a payment card and a satellite radio according to claim 1, wherein the subscriber account information comprises a shipping address.

3. The method for making a purchase using a payment card and a satellite radio according to claim 1, wherein a first radio frequency is used for the broadcast information and a second radio frequency is used for the purchase request.

4. The method for making a purchase using a payment card and a satellite radio according to claim 1, wherein the broadcast information comprises a code for identifying the goods or services.

5. The method for making a purchase using a payment card and a satellite radio according to claim 4, wherein the code is visually displayed on the satellite radio.

6. The method for making a purchase using a payment card and a satellite radio according to claim 1, wherein the payment card is a credit card, a debit card or a prepaid card.

7. The method for making a purchase using a payment card and a satellite radio according to claim 1, wherein the method further comprises assigning an order number to the request to purchase goods or services.

8. The method for making a purchase using a payment card and a satellite radio according to claim 1, wherein the method further comprises confirming the purchase via the satellite radio or by an electronic message.

9. The method for making a purchase using a payment card and a satellite radio according to claim 8, wherein the electronic message is an e-mail or a text message.

10. The method for making a purchase using a payment card and a satellite radio according to claim 1, wherein the method further comprises delivering the goods or services to a location identified in the subscriber account information.

11. A system for making a purchase using a payment card and a satellite radio comprising:
a satellite radio comprising a receiver and a transmitter;
radio programming comprising an advertisement for the sale of goods or services;
a payment card comprising a microprocessor chip or a magnetic stripe, wherein the microprocessor chip or magnetic stripe contains account information;
a payment card reader for reading the account information from the microprocessor chip or magnetic stripe, wherein the payment card reader communicates the account information to the satellite radio, and wherein the account information is transmitted via the satellite radio transmitter to purchase the advertised goods or services; and
software for receiving the account information and completing a sales transaction for the purchase of the advertised goods or services.

12. A system for making a purchase using a payment card and a satellite radio according to claim 11, wherein the satellite radio comprises one or more channels for receiving and transmitting satellite radio signals.

13. A system for making a purchase using a payment card and a satellite radio according to claim 11, wherein the satellite radio comprises a first radio frequency for receiving the radio programming and a second radio frequency for transmitting the account information.

14. A system for making a purchase using a payment card and a satellite radio according to claim 11, wherein the satellite radio or the payment card reader comprises a display screen, and wherein the advertisement is assigned a code, which is displayed on the display screen.

15. A system for making a purchase using a payment card and a satellite radio according to claim 11, wherein the system further comprises a keypad, a touch screen or a touch pad for entering information for transmission via the satellite radio, wherein the purchase is made using the keypad, touch screen or touch pad and the payment card.

16. A system for making a purchase using a payment card and a satellite radio according to claim 11, wherein the completed sales transaction is assigned an order number and wherein the order number is transmitted to a purchaser via the satellite radio, an e-mail or a text message.

17. A system for making a purchase using a payment card and a satellite radio according to claim 11, wherein the account information comprises a shipping address and wherein the purchased goods or services can only be shipped to the shipping address.

18. A system for making a purchase using a payment card and a satellite radio according to claim 11, wherein the payment card is a credit card, a debit card or a prepaid card.

19. A system for making a purchase using a payment card and a satellite radio comprising:
a satellite radio comprising a receiver, a transmitter, a display screen, a first channel for receiving a broadcast satellite radio signal and a second channel for transmitting a satellite radio signal;
radio programming comprising an advertisement for the sale of goods or services, wherein the advertisement is assigned a code and the code is displayed on the display screen;
a payment card comprising a microprocessor chip or a magnetic stripe, wherein the microprocessor chip or magnetic stripe contains account information;
a payment card reader for reading the account information from the microprocessor chip or magnetic stripe, wherein the payment card reader is connected to the satellite radio, and wherein the account information is transmitted via the satellite radio transmitter to purchase the advertised goods or services;
a keypad, a touch screen or a touch pad for entering information for transmission via the satellite radio, wherein the purchase is made using the keypad, touch screen or touch pad and the payment card; and
software for receiving the account information and completing a sales transaction for the purchase of the advertised goods or services.

20. A system for making a purchase using a payment card and a satellite radio according to claim 19, wherein the completed sales transaction is assigned an order number and wherein the order number is transmitted to a purchaser via the satellite radio, an e-mail or a text message.
